(19) United States
(12) Patent Application Publication
(10) Pub. No.: US 2005/0096774 A1
(43) Pub. Date: May 5, 2005

(54) System and method for integrating transactional and real-time manufacturing data

(76) Inventors: Deia Salah-Eldin Bayoumi, Fuquay Varina, NC (US); William John Vick, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/699,104

(22) Filed: Oct. 31, 2003

(51) Int. Cl. G06F 19/00; G06F 17/60

(52) U.S. Cl. 700/109; 700/100; 700/182; 700/96; 705/26; 705/28

(57) ABSTRACT

A method for controlling a manufacturing process integrates transactional and real-time data. Scheduling and inventory data relating to an item to be manufactured, as well as design data for the item to be manufactured are retrieved from a database. Control data derived from the inventory and design data is transmitted to a machine adapted to manufacture the item. Real-time event notification data is received from the manufacturing machine and the scheduling and inventory data updated to reflect the real-time event notification data.

### CROSS-REFERENCE TO RELATED APPLICATIONS

This application is related by subject matter to U.S. patent application Ser. No. ______ (not yet assigned) (Attorney Docket No. ABDT-0574) entitled “System and Method for Job Rescheduling” and filed on Oct. 31, 2003, the content of which is hereby incorporated by reference in its entirety.

### FIELD OF THE INVENTION

The disclosed systems and methods relate generally to business management systems and manufacturing control systems.

### BACKGROUND OF THE INVENTION

Modern businesses track and collect data regarding many aspects of their operations and use computers to collect and maintain that data. Indeed, computerized systems are used to track, store, manage, and report all types of business transactions. Such computerized systems are often referred to as transactional systems and are relied upon to assist in many administrative operations of a business such as, for example, sales, purchasing, planning, and finance. In a manufacturing setting, transactional systems are additionally employed to handle shop-floor transactions such as, for example, bills of materials, production orders, and quality systems. Generally, transactional systems employ database system software which is optimized to perform store and retrieve tasks. While transactional systems are fast and efficient, such systems typically need only have response times as fast as the transactions that they are tracking.

In some businesses such as, for example, those involved with manufacturing, real-time systems may be used in addition to transactional systems. Real-time systems are devoted to applications whose correctness are time dependent. Often, real-time systems are required to have response times on the order of milliseconds. In a manufacturing setting, real-time systems are used to control machinery and equipment. Such systems may involve the acquisition and analysis of tens, or even hundreds of thousands of data points per minute. The data processed by real-time systems is usually dependent upon a state associated with the process and/or whether a particular event has taken place. Generally, real-time systems rely only moderately, if at all, upon relational database software because, although fast by transactional standards, database software is generally too slow for many real-time operations. Real-time systems often employ programmable logic controllers (PLC's), which are relatively very fast. On a manufacturing line, each machine may have an associated PLC, and groups of similar machines may be nested within a master PLC configuration.

Applicants have noted that while businesses collect and process large amounts of both transactional and real-time data, business do not employ the data to its full potential. For example, while transactional data and real-time data is often related and inter-dependent, existing systems have not integrated transactional and real-time systems and their corresponding data sets to the extent possible. Indeed, most software vendors provide either real-time systems or transactional systems, but have not integrated the two.

### SUMMARY

Applicants disclose herein illustrative systems and methods for controlling manufacturing processes that leverage both transactional and real-time data. While the disclosed systems and methods may be applied to the manufacture of most any type of item, the systems and methods are described in the context of manufacturing of electrical distribution transformers.

The disclosed systems and methods rely on transactional data to prepare for manufacturing an item, receive real-time data during the manufacturing process, and update the transactional data to reflect the real-time data while the manufacturing is taking place. In response to a request at an operator workstation to initiate the manufacture of an item, scheduling data and inventory data relating to an item to be manufactured is retrieved. Likewise, design data relating to the item to be manufactured is retrieved. The data is used by an operator's terminal to create control signals, which are transmitted to at least one device such as, for example, a winding machine employed in manufacturing the item. The operator workstation receives real-time event notification as processes are implemented. This event notification information is forwarded by the operator workstation to an enterprise resource planning (ERP) system where it is used to update the transactional data stored therein. This updated data is immediately available to be used at the manufacturing site in response to all inquiries including, for example, responses to customer offers. Thus, as the real-time data is received, it is used to update the transactional data.

### BRIEF DESCRIPTION OF THE DRAWINGS

Other features of the illustrative system and method will be further apparent from the following detailed description taken in conjunction with the accompanying drawings, of which:

FIG. 1 is a diagram of an illustrative integrated transactional and real time system for manufacture of an electrical distribution transformer;

FIG. 2 is a software block diagram of an illustrative integrated transactional and real-time system for manufacture of an electrical distribution transformer;

FIG. 3 is a diagram illustrating the flow of information in an illustrative method for manufacturing an electrical distribution transformer;

FIG. 4 is a flow chart of an illustrative method for controlling the manufacture of an electrical distribution transformer; and

FIG. 5 is a diagram of an illustrative computer system for controlling the manufacture of an electrical distribution transformer.

### DETAILED DESCRIPTION OF ILLUSTRATIVE EMBODIMENTS

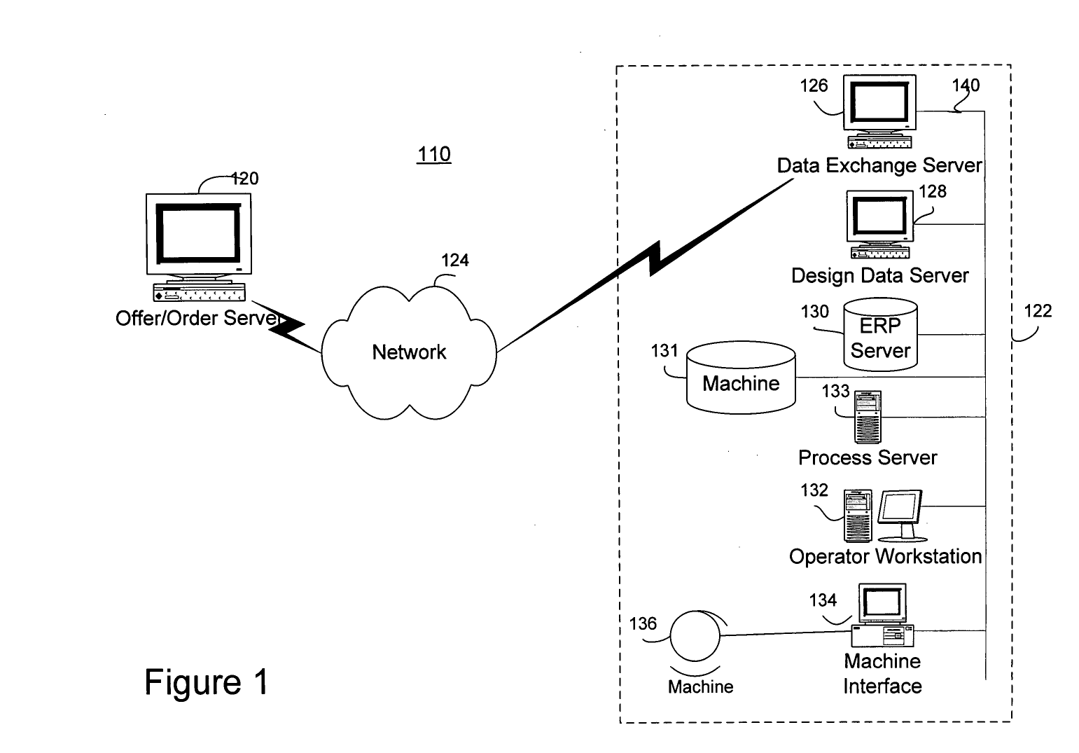

FIG. 1 is a diagram of an illustrative system 110, which may be employed to manufacture many different types of articles. For purpose of discussion, system 110 is described as being adapted to manufacture distribution transformers, although it could be used to manufacture all types of articles. As shown in FIG. 1, system 110 comprises offer/order server 120 which is employed to receive offers and orders for distribution transformers. Offer/order server 120 communicates offers and orders for transformers via network 124 to manufacturing facility 122. Network 124 may comprise wireless connectivity, wire based technology, or both. Further, network 124 may comprise private networks and public networks such as, for example, the Internet.

Manufacturing facility 122 is adapted to respond to orders received from network 124 and manufacture distribution transformers using the methods described below. Manufacturing facility 122 comprises data exchange server 126 which is adapted to receive customer offers from offer/order server 120 via network 124. Data exchange server 126 communicates over LAN 140 with process server 133, operator workstation 132, and ERP server 130 to determine whether there is the capacity at the particular manufacturing facility 122 to manufacture an item specified in an order as well as to control the manufacture of that item.

ERP server 130 is an ERP business application server that provides access to transactional data such as, for example, sales, bills of material, planning, manufacturing routing, inventory, and procurement data. This data may be accessed on demand whenever necessary and is updated when there are developments in the system that change the data. During operation of the manufacturing system, ERP server 130 is accessed to retrieve, for example, information relating to the orders to be filled as well as the production schedule. The transactional data stored in ERP server is updated during the manufacturing process to reflect changes in the inventory of raw materials, in schedules, and the inventory of completed and partially completed product that have resulted from the ongoing manufacturing process.

Design data server 128 has stored thereon and provides access to design data for distribution transformers that have been manufactured at or are scheduled to be manufactured at the particular manufacturing facility 122. Design data server 128 comprises the electrical and manufacturing design data for the transformers along with the machine instructions for performing the manufacturing operations necessary to make the transformer. In one embodiment, design data server 128 may comprise, for example, electronic drawings, e.g. CAD drawings, that specify the components and measurements for the distribution transformers. The specification data on design data server 128 may be accessed by process server 133 and operator workstation 132 for use in the manufacture of an item specified in a new order.

Machine attribute database 131 comprises data regarding the manufacturing machines 136 located at facility 122. More particularly, machine attribute database 131 may comprise specifications, functional capabilities, and scheduled capacity for each machine 136 at facility 122. Further, database 131 may comprise data specifying the routing characteristics and schedules for each machine 136. Finally, database 131 may comprise data specifying the meaning of various notification, status, and alarm data that are generated by machines 136 and transmitted to process server 133.

Process server 133 operates to coordinate the scheduling of manufacturing jobs at various machines 136 at facility 122. Process server 133 receives status and notification data from operator workstations 132 during the manufacturing process. If the status or notification data indicates a particular machine has become unavailable, process server 133 queries machine attribute database 131 to identify another machine 136 at facility 122 that has substantially the same functional capabilities and a schedule that will allow for receiving jobs originally scheduled to be completed by the now unavailable machine. Upon identifying such a machine, process server 133 communicates, possibly via data exchange server 26, updated schedules to the appropriate operator workstations 132 associated with the failed machine and the identified replacement machine. The updated schedules move jobs originally scheduled to be completed by the failed machine to the replacement machine.

Operator workstation 132 is adapted to allow an operator to control the manufacture of items at facility 122. More particularly, operator workstation 132 provides a user interface that allows an operator to start, stop, re-start, and terminate the manufacture of transformers. Operator workstation 132 communicates over LAN 140 with machine interface computer 134 to control the operation of manufacturing machines 136. Operator workstation 132 communicates control signals to machine interface 134 and thereby causes machine(s) 136 to perform certain manufacturing processes. Machine interface 134 communicates directly with machine(s) 136 and relays any feedback data including status, notifications, and alarms back to operator workstation 132. Operator workstation 132 forwards status, notification, and alarm information back to process server 133 for additional evaluation. The manufacturing jobs and schedules that are assigned to operator workstations 132 originate at, and may be modified by process server 133.

Machines 136 are adapted to physically create a distribution transformer and are controlled by operator workstation 132 via machine interface 134. Machines 136 may be adapted to perform activities for the manufacture of a distribution transformer such as, for example, cutting, winding, annealing, etc. Generally, machines 136 are adapted to communicate in OPC standard protocols, although other protocols may be used.

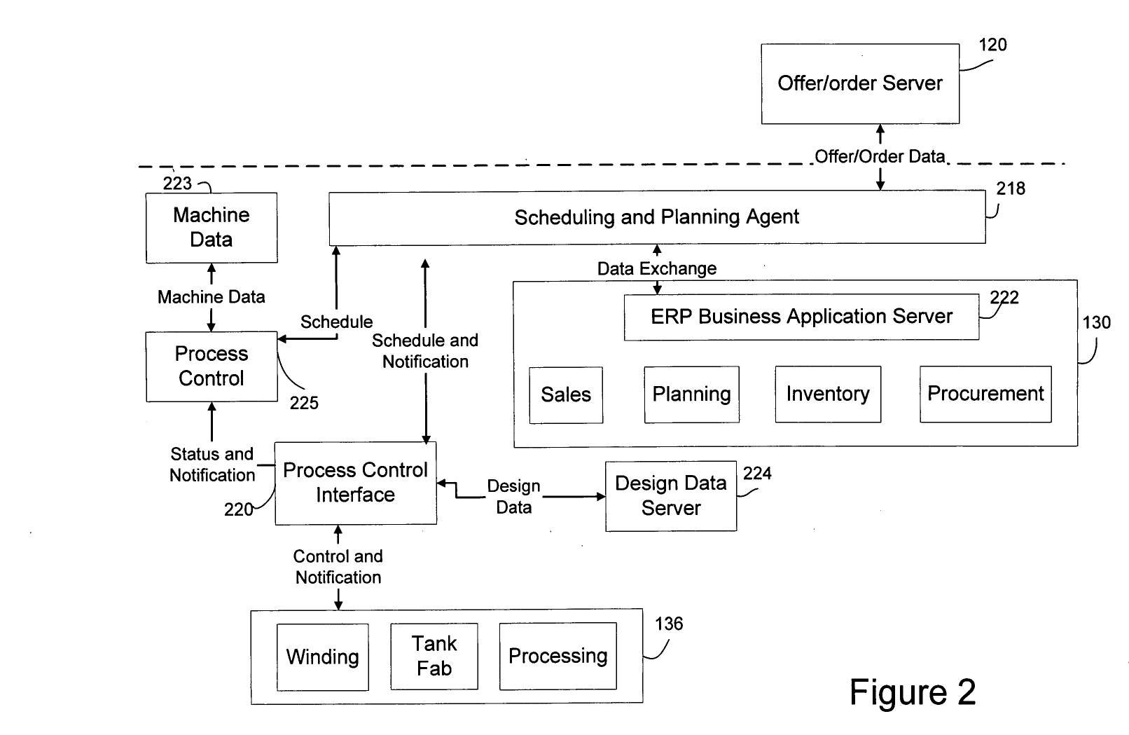

FIG. 2 is a block diagram illustrating software components and data flow in an illustrative system for manufacturing a distribution transformer. As shown, offers and orders for distribution transformers are received from offer/order server 120. Offer and order data are received at scheduling and planning agent software 218, which executes on data exchange server 126. Scheduling and planning agent software 218 queries ERP business application server software 222 and process control interface software 220 executing on workstations 132 to determine whether the particular manufacturing facility 122 has the capability and schedule of production which will allow for the manufacture of the item specified in the customer offer.

During manufacture of a distribution transformer, process control interface software 220 receives design data from design data server software 224 and machine data from machine data server software 223. Process control interface software 220 communicates control data via computer interface 134 to machines 136, and receives status and event notification from machines 136. Process control interface software 220 forwards event notification and status data to process control server software 225 and scheduling and planning agent software 218. Scheduling and planning agent software 218 forwards the event notification and status data to ERP application server software 222.

Process control server software 225 monitors the status and notification data from process control interface 220 and may query machine data server software 223 in response to the status and notification data. Control server software 225 may forward updated scheduling information to process control interface 220 via scheduling and planning agent 218 to cause jobs to be reassigned from one machine to another, as described in detail in U.S. patent application Ser. No. ______ (not yet assigned) (Attorney Docket Number ABDT-0574) entitled “System and Method for Manufacturing Job Rescheduling” filed on Oct. 31, 2003, the content of which is hereby incorporated by reference in its entirety.

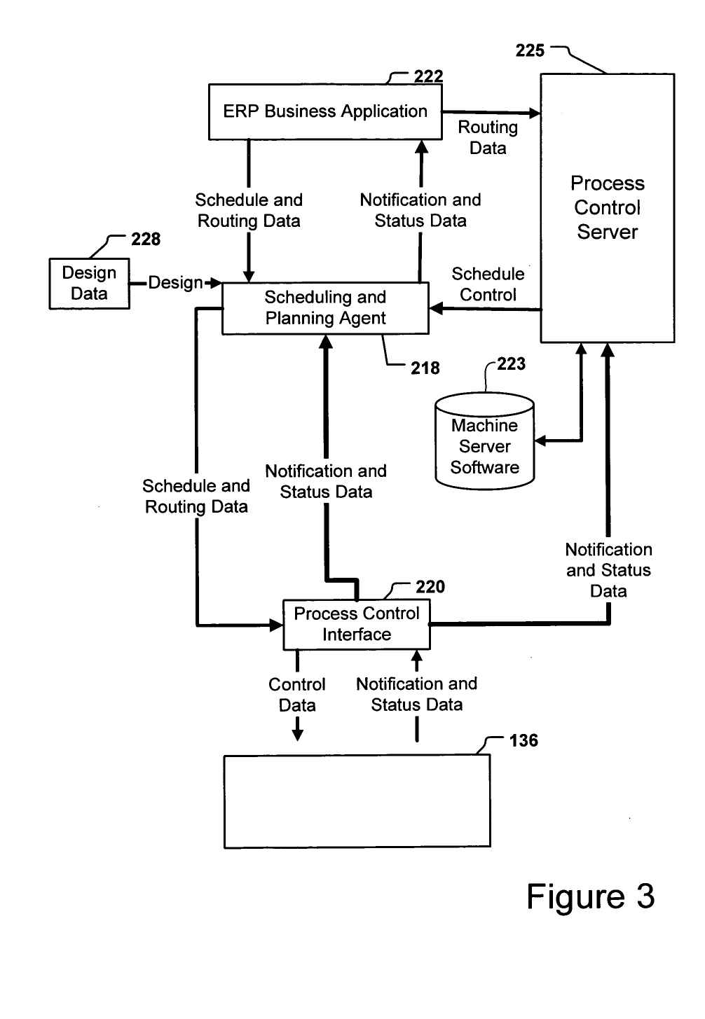

FIG. 3 provides a diagram depicting the flow of data during the manufacture of an ordered transformer. As shown, when manufacture of an item is initiated, planning data including scheduling and routing data relating to the manufacture of an ordered transformer is retrieved from ERP business application server 222 to scheduling and planning agent 218. For example, bill of material, routing, and material availability data may be retrieved from server 222 to scheduling and planning agent 218. Scheduling and planning agent 218 requests and receives design data from design data server 228. For example, drawings for the transformer and machine instructions for manufacturing the transformer may be received by scheduling and planning agent 218. The schedule data and design data are routed to process control interface 220. Process control interface 220 employs the schedule and design data to control manufacturing machines 136 via interface 134 (not shown). During the manufacture of the item, machines 136 transmit event notification and alarm data to process control interface 220. Process control interface 220 transmits the event notification data to process control server 225 and scheduling and planning agent 218, which updates ERP business server 222 to reflect the notification data. Thus, even while a transformer is being manufactured, the real-time event notification data received at process control interface 220 is reflected in the transactional data stored in ERP application server 222. Accordingly, the disclosed systems and methods provide improved integration between the two different types of systems.

Process control server 225 queries machine server software 223 to retrieve information about the status and notification data that was forwarded. If the status and notification data indicate a machine has become unavailable, process control server queries server software 223 to identify a machine that has substantially the same capabilities as the unavailable machine. Process control server software 225 may communicate manufacturing schedule updates to scheduling and planning agent 218. These updates are then communicated to process control interface software 220 operating on machines 136.

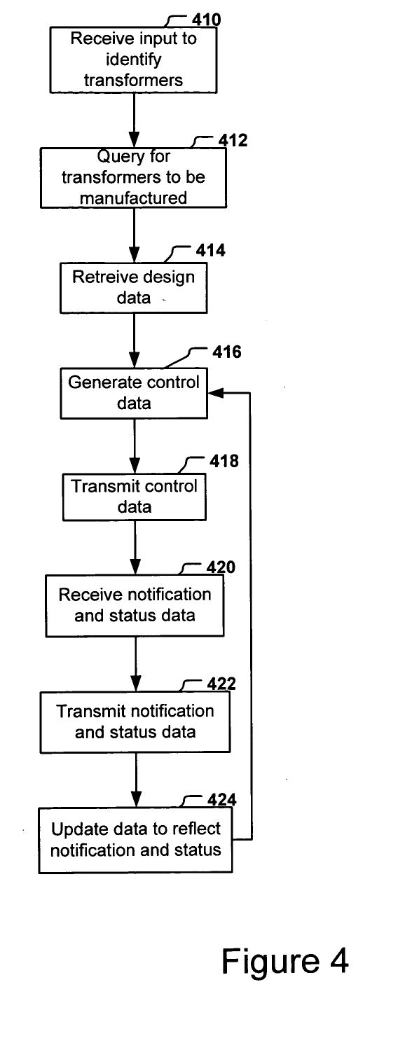

FIG. 4 depicts a flow chart of an illustrative method for controlling the manufacture of a distribution transformer. As shown, at step 410, process control interface software 220 executing on operator workstation 132 receives a user input to identify transformers that are scheduled to be manufactured. At step 412, process control interface software 220 queries scheduling and planning agent software 218 for the transformers that are scheduled to be manufactured. A list of transformers scheduled to be manufactured are returned to process control interface software 220 and displayed on workstation 132.

At step 414, in response to a selection by the user of a particular distribution transformer to be manufactured, process control interface software 220 retrieves design data corresponding to the particular transformer from design data server software 224. The design data provides sufficient information from which the selected transformer can be manufactured. In one embodiment, the design data may comprise electronic drawings that provide sufficient specificity from which the transformer may be manufactured.

At step 416, process control interface software 220 generates control data that is used to control machines 136. The control data may be generated in any of numerous formats such as, for example, XML formatted data or OPC formatted data. At step 418, the control data is transmitted to the actual machine 136 or possibly to a machine interface 134 through which a machine 136 is controlled.

At step 420, process control interface software 220 receives notification and status data from machines 136, possibly through machine interface 134. The notification and status data identifies events such as the completion of an intermediary component or the end of a process in the manufacture of the components. More particularly, the notification data may identify a start time, a stop time, an elapsed time, alarms indicating manufacturing parameters are outside the specifications, machine running status, and machine malfunction status.

At 422, process control interface software 220 transmits the updated notification data to ERP application server software 222. At step 422, ERP application server software 222 updates its data to reflect the notification data. Because ERP application server software 222 is repeatedly updated with the most recent notification data, subsequent requests to ERP application server software 222 reflect the most current data.

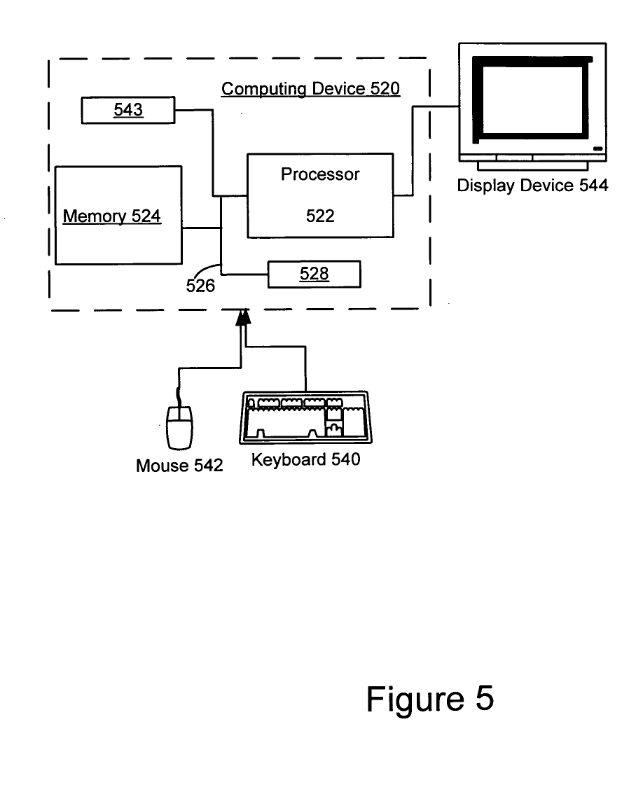

FIG. 5 is a diagram of an illustrative computing system that may be used to implement any of computing systems 120, 126, 128, 130, 132, and 134 discussed above. As shown in FIG. 5, computing device 520 includes processor 522, system memory 524, and system bus 526 that couples various system components including system memory 524 to processor 522. System memory 524 may include read-only memory (ROM) and/or random access memory (RAM). Computing device 520 may further include hard-drive 528, which provides storage for computer readable instructions, data structures, program modules, data, and the like. A user (not shown) may enter commands and information into computing device 520 through input devices such as keyboard 540 or mouse 542. Of course different input devices such as a telephone or PDA keypad or voice recognition input apparatus may also be used. A display device 544, such as a monitor, a flat panel display, or the like is also connected to the computing device 520 or output. Display device 544 may also include other devices such as a touch screen for inputting information into processor 522. Communications device 543, which may be a modem, network interface card, or the like, provides for communications over networks 124 and 140.

Processor 522 can be programmed with instructions to interact with other computing systems so as to perform the methods described above. The instructions may be received from network 140 or stored in memory 524 and/or hard drive 528. Processor 522 may be loaded with any one of several computer operating systems such as WINDOWS NT operating system, WINDOWS 2000 operating system, LINUX operating system, PalmOS, and the like.

Those skilled in the art understand that computer readable instructions for implementing the above-described processes, such as those described with reference to FIGS. 3 and 4 can be generated and stored on one of a plurality of computer readable media such as a magnetic disk or CD-ROM. Further, a computing device such as that described with reference to FIG. 5 may be arranged with other similarly equipped computers in a network, and may be loaded with computer readable instructions for performing the above described processes. Specifically, referring to FIG. 5, microprocessor 522 may be programmed to operate in accordance with the above-described processes.

Thus, systems and methods for controlling the manufacture of a distribution transformer have been disclosed. According to a first aspect of the disclosed systems and methods, the systems and methods rely on transactional data to prepare for manufacturing an item, receive real-time data during the manufacturing process, and update the transactional data to reflect the real-time data while the manufacturing is taking place. Thus, as the real-time data is received, it is reflected in the transactional data. Accordingly, the illustrative systems provide improved integration of transactional and real-time systems.

While the disclosed systems and methods have been described and illustrated with reference to specific embodiments, those skilled in the art will recognize that modification and variations may be made. For example, while the disclosed embodiments relate to manufacture of electrical distribution transformers, the disclosed systems and methods may be employed to control the manufacturing of any type of item. Accordingly, reference should be made to the appended claims as indicating the scope of the invention.

1. A method for controlling a manufacturing process, comprising:
retrieving to a user interface in response to a user request at least one of scheduling and inventory data relating to an item to be manufactured;
retrieving to the user interface in response to a user request design data corresponding to the item to be manufactured;
transmitting in response to a user request at the user interface control data to at least one device adapted to manufacture the item;
receiving at the user interface real-time manufacturing event notification data from the at least one device; and
updating at least one of scheduling and inventory data to reflect-the real-time manufacturing event notification data.

2. The method of claim 1, wherein retrieving to a user interface in response to a user request at least one of scheduling and inventory data relating to an item to be manufactured comprises retrieving data relating to materials required to manufacture the item.

3. The method of claim 1, wherein retrieving to a user interface in response to a user request at least one of scheduling and inventory data relating to an item to be manufactured comprises retrieving data relating to the scheduling of multiple processes adapted to manufacture the item.

4. The method of claim 3, wherein retrieving data relating to the scheduling of multiple processes adapted to manufacture the item comprises retrieving data relating to scheduling of winding, tank fabrication, and processing.

5. The method of claim 1, wherein retrieving to a user interface in response to a user request design data comprises retrieving electronic drawing data corresponding to the item to be manufactured.

6. The method of claim 5, further comprising deriving from the electronic drawing data control signal data.

7. The method of claim 1, wherein transmitting control signal data comprises transmitting OPC formatted data.

8. The method of claim 7, further comprising converting XML formatted data to OPC formatted data.

9. The method of claim 1, wherein receiving real-time manufacturing event notification data from the at least one device comprises receiving data indicating manufacture of the item is complete.

10. The method of claim 1, wherein receiving real-time manufacturing event notification data from the at least one device comprises receiving data indicating an intermediary event in the manufacture of the item is complete.

11. The method of claim 10, wherein receiving data indicating an intermediary event in the manufacture of the item is complete comprises receiving data indicating at least one of cutting, winding, assembly in the manufacture of a transformer core is complete.

12. The method of claim 1, wherein updating the at least one of scheduling and inventory data comprises updating data to identify an event in the manufacture of the item is complete.

13. The method of claim 1, wherein updating the at least one of scheduling and inventory data comprises updating scheduling and inventory data to identify at least one of a transformer core has been cut, a transformer core has been wound, and a transformer core has been assembled.

14. A system for controlling a manufacturing process, comprising:
an enterprise resource planning (ERP) server, said ERP server having stored thereon transactional data comprising scheduling and inventory data relating to an item to be manufactured, and said ERP server adapted to receive requests and provide access to the scheduling and inventory data;
a scheduling and planning agent in communication with said ERP server, said scheduling and planning agent adapted to receive requests for schedule and inventory data, retrieve schedule and inventory data from said ERP server, and transmit schedule and inventory data to said ERP server; and
a process control interface in communication with said scheduling and planning agent, said process control interface adapted to request scheduling and inventory data in response to a user request, request design data in response to a user request, transmit control signals to a manufacturing machine in response to a user request, receive real-time event notification data from the manufacturing machine, and transmit the real-time event notification data to said scheduling and planning agent,
wherein said scheduling and planning agent is further adapted to forward the real-time event notification data to said ERP server and said ERP server is further adapted to update the transactional scheduling and inventory data to reflect the real-time event notification data.

15. The system of claim 14, further comprising a design data server communicatively coupled to said scheduling and planning agent, said design data server having stored thereon design data specifying design characteristics of the item to be manufactured, wherein said scheduling and planning agent is adapted to retrieve said design data in response to a user request.

16. The system of claim 14, wherein said event notification data comprises data indicating manufacture of the item is complete.

17. The system of claim 14, wherein said event notification data comprises data indicating an intermediary event in the manufacture of the item is complete.

18. A method for integrating transactional and real-time manufacturing data, comprising:
maintaining a database comprising transactional data comprising scheduling and inventory data;
maintaining a database comprising design data;
retrieving transactional data comprising scheduling and inventory data to a user interface in response to a user request;
retrieving design data to the user interface in response to a user request;
at the user interface, controlling a manufacturing machine using at least in part the design data;
at the user interface, receiving real-time event notification data from the manufacturing machine; and
updating the database comprising transactional data comprising scheduling and inventory data to reflect the real-time event notification data.

19. The method of claim 18, wherein receiving real-time notification data comprises receiving data indicating an intermediary event in a manufacturing process has been completed.

20. The method of claim 19, wherein updating the database comprises updating the inventory data.
